(19) United States
(12) Patent Application Publication
(10) Pub. No.: US 2008/0259886 A1
(43) Pub. Date: Oct. 23, 2008

(54) Plain Old Telephony Equivalent Services Supported Via Unlicensed Mobile Access

(76) Inventors: Frank Laursen Svarre, Herning (DK); Jorgen Karkov, Struer (DK); Peter Bach, Struer (DK)

Correspondence Address: ERICSSON INC., 6300 LEGACY DRIVE, M/S EVR 1-C-11, PLANO, TX, 75024, US

(21) Appl. No.: 11/815,710

(22) PCT Filed: Feb. 7, 2005
(86) PCT No.: PCT/SE2005/000153

§ 371 Date: Aug. 7, 2007

(51) Int. Cl. H04Q 7/20

(52) U.S. Cl. 370/338

(57) ABSTRACT

An access point (21) of an unlicensed mobile access network is provided with an analogue physical interface (26), arranged for communication with plain old telephony system—POTS—equipment (60). A converter (22) connected to the analogue physical interface (26) converts POTS signalling (65) into signalling (25) for a mobile communications system, and vice versa. The POTS-to-mobile converter (22) is connected to a converter (24) preferably according to the UMA standard for packeting and unpacketing of mobile communications system signalling (25) into IP packets (35). The POTS-to-mobile converter (22) is provided with an identity (23) that is interpretable by the mobile communications network. POTS services not directly available through the mobile communication network are preferably implemented in or in connection to the POTS-to-mobile converter (22).

### TECHNICAL FIELD

The present invention relates in general to telecommunications and in particular to devices offering telephony services provided over Internet protocol connections.

### BACKGROUND

Communication systems utilising communication based on the Internet protocol (IP) have been developed enormously during the last few years. One of the attractive features is the availability of high bandwidths enabling very high transmission rates. Also telephony services are involved in this development. Recently, a new standard [1] for unlicensed mobile access (UMA) has been released, in which mobile stations equipped to enable communication via unlicensed spectrum technologies, such as WiFi or Bluetooth, utilises broadband IP networks for connecting to mobile communications systems.

However, services associated with plain old telephony systems (POTS) are still requested. Different approaches have been suggested. One approach is to provide a node connected to POTS equipment, that packetises POTS data into IP packets, which are sent over an IP network to a gateway node, where the POTS data is unpacked and forwarded to a POTS network. A problem with such solutions is that new equipment is needed at the user side as well as at the operator side.

Another approach is to develop mobile stations for supporting also different types of POTS equivalent services. The mobile stations can then be connected using e.g. the UMA technology. However, this approach requires more expensive and complicated mobile stations. Furthermore, there is no or at least limited possibilities to use POTS equivalent services at the same time as e.g. normal mobile telephony, since the mobile station is occupied.

### SUMMARY

A general problem with prior art solutions for utilising IP connections for POTS equivalent services is that they are generally relatively expensive and complicated.

An object of the present invention is thus to improve the possibilities to use IP networks for POTS services. A subsidiary object of the present invention is to provide POTS equivalent services over IP networks in inexpensive and simple manners.

The above objects are achieved by devices according to the enclosed claims. In general words, an access point (AP) of an access network, intended for access for mobile terminals to a mobile communications network over an IP connection, is provided with an analogue physical interface, arranged for communication with plain old telephony system (POTS) equipment. The access network is preferably an unlicensed mobile access network (UMAN) for connection to a GSM/3GPP communications system or similar access networks for connection to mobile networks using TDMA, CDMA-one, D-AMPS, PDC or PCS.

A converter in the AP connected to the analogue physical interface converts POTS signalling into signalling for a mobile communications system, and vice versa, hereinafter called POTS-to-mobile converter. The POTS-to-mobile converter is connected to a converter, in a GSM/3GPP implementation preferably according to the UMA standard, for packeting and unpacketing of mobile communications system signalling into IP packets. The POTS-to-mobile converter is provided with an identity that is interpretable by the mobile communications network. POTS services not directly available through the mobile communication network are preferably implemented in or in connection to the POTS-to-mobile converter.

The present invention has advantages in the areas of availability and cost of operation. Cost advantages are achieved due to the fact that POTS telephony services are integrated into mobile telephony at only an incremental cost. By reusing existing authentication according to mobile standards and e.g. UMA standard, subscriber activation and administration can be significantly reduced.

### BRIEF DESCRIPTION OF THE DRAWINGS

The invention, together with further objects and advantages thereof, may best be understood by making reference to the following description taken together with the accompanying drawings, in which:

FIG. 1 is a schematic block scheme of an UMA system;

FIG. 2 is a schematic block scheme of a system for voice over IP;

FIG. 3A is a schematic block scheme of a part of a communications system according to an embodiment of the present invention;

FIG. 3B is a schematic block scheme of a part of a communications system according to another embodiment of the present invention;

FIG. 4 is a schematic block diagram of an embodiment of an access point according to the present invention;

FIG. 5 is an illustration of an embodiment of protocol architecture for a system according to the present invention;

FIG. 6 is a block diagram of an embodiment of an access point according to the present invention;

FIG. 7 is a block overview diagram of an embodiment of an access point according to the present intention; and

FIG. 8 is a block diagram of tone handling in an access point according to e.g. FIG. 7.

### DETAILED DESCRIPTION

In order to better understand the characteristic features of the present invention, prior art UMA systems and voice over IP systems are discussed in a summarized manner.

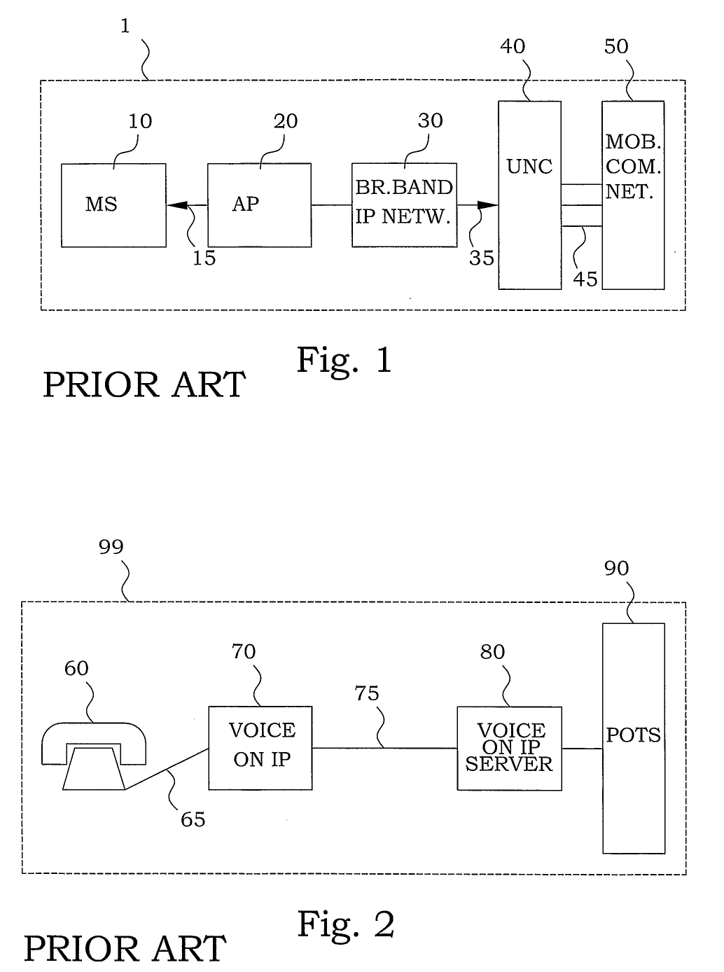

FIG. 1 illustrates a UMA network 1 according to the UMA stage 2 architecture. A mobile station 10 communicates with an access point 20 over a radio link 15 using unlicensed spectrum (e.g. 802.11 or Bluetooth). A broadband IP network 30 provides connectivity between the access point 20 and a UMA network controller (UNC) 40. An interface 35, Up, is defined between the UNC 40 and the mobile station 10. The UNC 40 is then by different interfaces 45, further connected to a node 50 comprising VPLMN/HPLMN (Visited Public Land Mobile Network/Home Public Land Mobile Network) functionalities.

There are certain salient features of the UMA system. The mobile station 10 and the UNC 40 are new or enhanced entities. The UMA network co-exists with the GSM/GPRS radio access network and interconnects to the GSM core network via the same interfaces used by a standard GERAN BSS network element; a GSM A-interface for circuit switched voice services and a GPRS Gb interface for packet data services. Use of AAA servers over a Wm interface as defined by 3GPP is also provided. The AAA server is used to authenticate the mobile station when it sets up a secure tunnel. The UNC 40 appears to the GSM/GPRS core network as a GERAN base station subsystem (BSS). In this architecture the principle elements of transaction control (e.g. call processing) and user services are provided by the network elements in the core network, namely the MSC/VLR and the SGSN/GGSN.

FIG. 2 illustrates a Voice over IP system 99. A POTS (Plain Old Telephony Service) terminal 60 is connected by 2-wire analogue connections 65 to an IP packeting node 70. The IP packeting node 70 packetises the POTS signals in IP packets and distributes the IP packets over an IP connection 75 to a server 80. The server 80 comprises means for unpacketizing the POTS signals and to connect them to a POTS system 90.

The two solutions of FIG. 1 and FIG. 2 may be combined so that they use the same broadband IP network for transmitting the signals. However, in such a case, a server 80 has to be provided in parallel to the UNC 40 since the definition of the Up interface 35 is not applicable on Voice over IP.

According to the present invention, POTS is instead provided by an UMA-type of system via a node 50 connected to a mobile communications system. Since mobile communications systems and POTS systems are interconnected and compatible at least concerning POTS, it doesn't matter if the connection to the land based system can is made via a mobile communications system. A conversion between POTS signalling and mobile communications signalling is made already in an access point, whereby the transfer over the IP network takes place by mobile communications system signals packeted in IP packets, instead of POTS signals packeted in IP packets. This conversion already at the access point completely removes the need for any additional server at the network side.

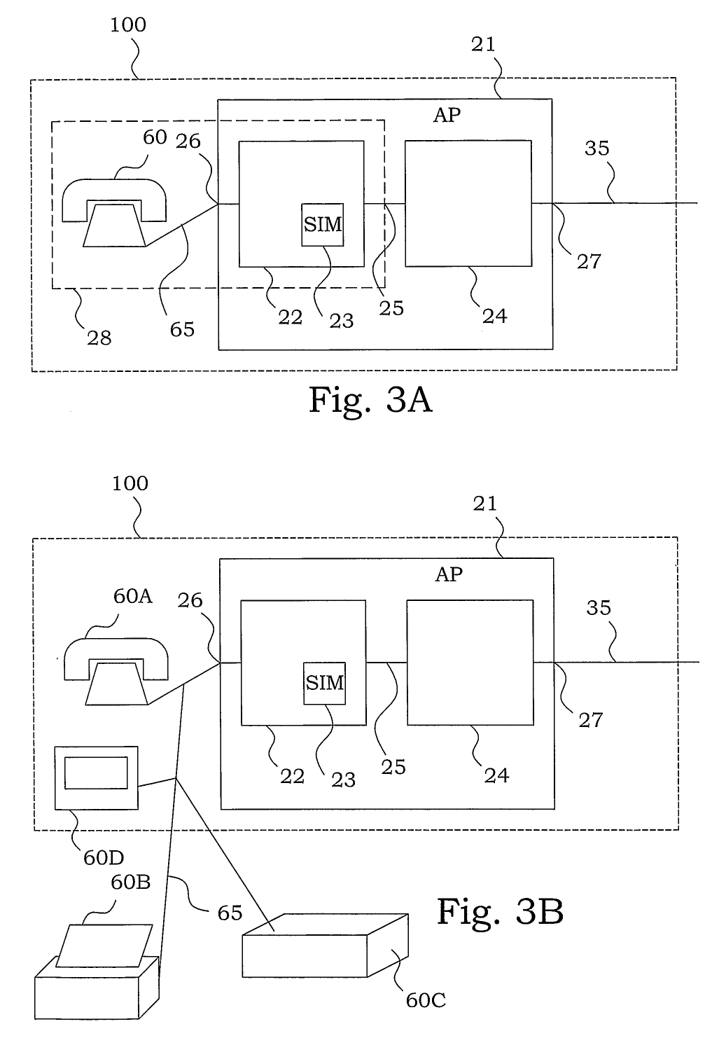

FIG. 3A is a schematic block scheme of a part of a communications system 100 according to an embodiment of the present invention. POTS equipment 60 is connected by 2-wire analogue connections 65 to an analogue physical interface 26 of an access point 21. A converter 22 is connected to the analogue physical interface 26 and arranged for terminating the POTS signalling and for converting the content into signals 25 of a mobile communications system. Another converter 24 is connected to the converter 22 for receiving and transferring signals 25 according to a mobile communications system. The converter 24 is also connected to an IP network physical interface 27, connected to an unlicensed mobile access (UMA) network. The converter 24 is arranged for converting IP signalling received on said IP network physical interface 27 into mobile communications system signalling 25 and for converting mobile communications system signalling 25 into IP signalling for transmission on said IP network physical interface 27. The converter 24 thus operates for packing and unpacking mobile communications signals into IP packets.

Such an arrangement will result in that the POTS equipment 60 is seen from the core network just as an ordinary mobile station. At the same time, the POTS interface 26 is seen from a user just as a normal POTS line. Since the core network of the mobile communications system to which the system of FIG. 3A is connected recognises the POTS equipment as a mobile station, the POTS equipment has to be associated with a unique identification, like all mobile stations. In the present embodiment, the converter 22 in the access point 21 is provided with a SIM (Subscriber Identity Module) card 23, having such an identity registered. The converter 22 and the POTS equipment will then constitute an imaginary mobile station 28, indicated by a dotted line.

In other words, the access point 21 converts the GSM/3G signalling into POTS equivalent signalling. The access point 21 is further equipped with information (e.g. a SIM card) that makes it possible to be perceived by the GSM/3G core network as a mobile station. The UNC and the GSM/3G core network are thus unaltered.

The legacy CPE (Customer Premises Equipment) POTS equipment is connected to the 2-wire analogue POTS interface 26 as if it would have been a normal POTS line. The CPE POTS equipment is thus unaltered. The access point 21 is thereby the only equipment in which alterations have to be presented.

FIG. 3B illustrates another embodiment of an access point according to the present invention. Here several CPE POTS equipment devices 60A-D are connected to the 2-wire analogue connection 65, in an analogue manner to a normal POTS system. In FIG. 3B, a telephone 60A, a fax apparatus 60B, an analogue modem 60C and CLIP (Call Line Identification Presentation) display 60D are illustrated as non-limiting examples of CPE POTS equipment devices.

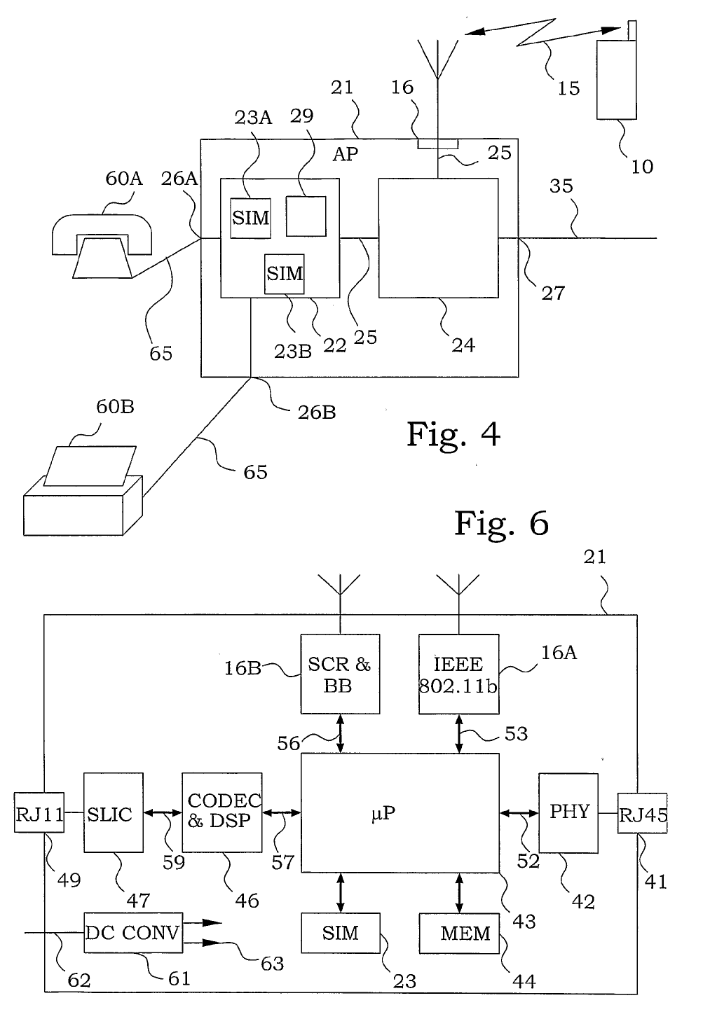

FIG. 4 illustrates a block scheme of another embodiment of an access point according to the present invention. The converter 22 is here connected to two analogue physical interfaces 26A, 26B, in turn connected to two POTS equipments 60A, 60B. Each of the analogue physical interfaces 26A, 26B are associated with a separate SIM 23A, 23B, whereby the POTS equipments 60A, 60B appears as two mobile stations from the mobile communications system point of view, i.e. two subscriptions.

In FIG. 4, the access point 21 can also be used as a standard access point of an UMA system. The converter 24 is connected via a mobile interface 16 to an antenna operating with unlicensed spectra for communication via a radio link 15 to a mobile station 10. These parts are preferably arranged according to the UMA standard and is not further discussed.

The POTS services are achieved by using the GSM/3G signalling over the Up interface towards the GSM/3G core network. Many POTS services are directly available from the core network. Other services are implemented in the access point 21. In FIG. 4, means 29 for implementing POTS services are provided in or in connection to the converter 22. Generators and detectors for POTS specific tones and pulses are typically provided in this means 29.

Non-exclusive examples of POTS services of interest are POTS voice support, POTS supplementary services, FAX support, modem support, TTY (Text telephony) support and high speed circuit switch data support. Non-exclusive examples of POTS supplementary services are presented in the list below:
Anonymous Call Rejection (ACRJ)
Call Forwarding (CF)
Call Forwarding Busy (CFB)
Selective Call Forwarding (SCFU)
Calling Line Identification Presentation (CLIP)
Calling Line Identification Restriction (CLIR)
Call Return (CR)
Call Waiting (CW)
Completion of Calls to Busy Subscriber (CCBS)
Distinctive Alerting Service, Additional Digit Method (DAA)
Do Not Disturb Service (DDB)
Equal Access (EA)
Message Waiting Indicator (MWI)
Selective Call Rejection (SCR)
Three Party Service (3PTY)
Three Party Service with Transfer (3PTYT)
Calling Name Identification Restriction (CNIR)

In a preferred embodiment, one main feature of the access point 21 is a PSTN (RJ-11) interface where the end user can connect one or a few standard telephones and other legacy equipment that works over PSTN. Another main feature of an access point 21 of a preferred embodiment is an Ethernet interface (RJ-45) for connection to an IP broadband access network (WAN), or e.g. over a Cable TV modem and network.

Preferably, the PSTN interface supports both DTMF and pulses. Quality of Service (QoS) is supported with DiffServ (IP TOS field is set to appropriate value). Fax and modem should preferably be supported. Non-exclusive examples of supported modems are V.90, V.34, V.32bis, V.32, V.22bis, V.22, V.23, V.21, Bell212A&103. Non-exclusive examples of supported FAX are Group 3 FAX transmission 2400/4800/7200/9600 baud.

In a preferred embodiment, the access point 21 is further arranged to automatically detect on the PSTN interface, if voice or FAX/modem are used and use a relevant codec (e.g. EFR, AMR etc.) for voice and FAX/modem. Preferably, the access point should support data (9600 bit/s) and high speed circuit switch data HSCSD.

SMS messages and identity of Calling Line could be presented on a display, connected to the 2-wire line. The information is transferred on the 2-wire line using e.g. FSK and/or DTMF signalling. SMS messages could be sent with soft-keyboard and integrated display or an external display. The access point 21 preferably also supports call name display and personal phonebook.

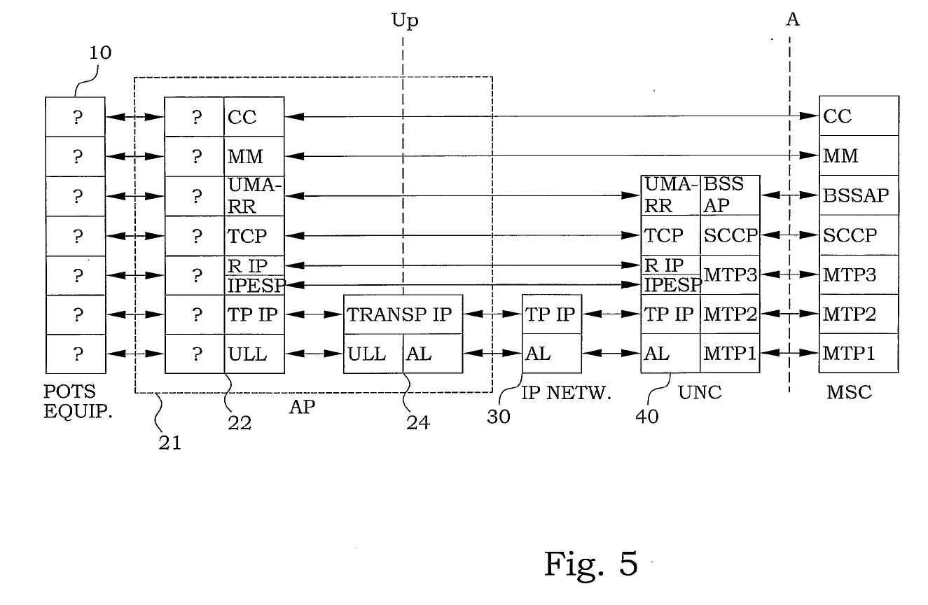

In FIG. 5, an embodiment of a protocol architecture for a system according to the present invention is illustrated. An MSC communicates over an A interface with an UNC 40 according to conventional protocols. The UNC 40 and IP network 30 are further arranged for using protocols according to the UMA standard. An access point 21 according to the present invention is in this embodiment terminating the access layers AL and instead applies unlicensed lower layers ULL for communication within the access point 21. This enables an easy connection also of true mobile stations to the converter 24, which then appears as a conventional UMA access point. The converter 22 that terminates the mobile communications signals and transfers them into POTS signals. Paging may e.g. be transferred into a ringing voltage sequence applied to the 2-wire line.

As anyone skilled in the art realises, the different parts of the access point embodiments presented above should be considered more as functional block rather than physical ones. These functional blocks could be implemented in separate units, integrated in one or a few common units, could be distributed to more than a single unit or any combinations thereof.

One possible embodiment of an implementation of some of the functional blocks is illustrated in FIG. 6, together with internal interfaces. An RJ45 Ethernet interface 41 is connected to a PHY unit (Ethernet Physical Layer Device) 42. The PHY unit is connected by a MII (Media Independent Interface) 52 to a microprocessor 43. The microprocessor 43 is arranged to perform most of the functionalities of e.g. the converter 24 in previous figures. The microprocessor 43 is connected by a PCI (Peripheral Component Interconnect) interface 53 to a radio unit 16A according e.g. to IEEE 802.11b. This radio unit 16A handles communication over a WiFi network. The microprocessor 43 in this embodiment is also connected to a radio unit 16B for Bluetooth communication e.g. a singlechip Radio and BB (Base Band). The radio units 16A and 16B are typically co-existing. The microprocessor 43 is also arranged to handle the SIM-related functionalities and is therefore connected to a SIM unit 23. The microprocessor 43 has furthermore access to a memory 44.

A PCM & HPI (Host Port Interface) 57 connects the microprocessor with a Codec and DSP (Digital Signal Processor) unit 46. This unit 46 is responsible for Voice codecs, Tone recognition, Tone generation, Fax modem and Data modem. A high/low voltage SLIC (Subscriber Line Interface Circuit) interface 59 connects the Codec and DSP unit 46 with a SLIC unit 47. Finally, the SLIC unit 47 is connected to a RJ11 (or equivalent) POTS 2-wire interface 49.

The access point 21 is powered by a power line 62 and a DC converter 61 provides suitable DC supply voltages to the different units.

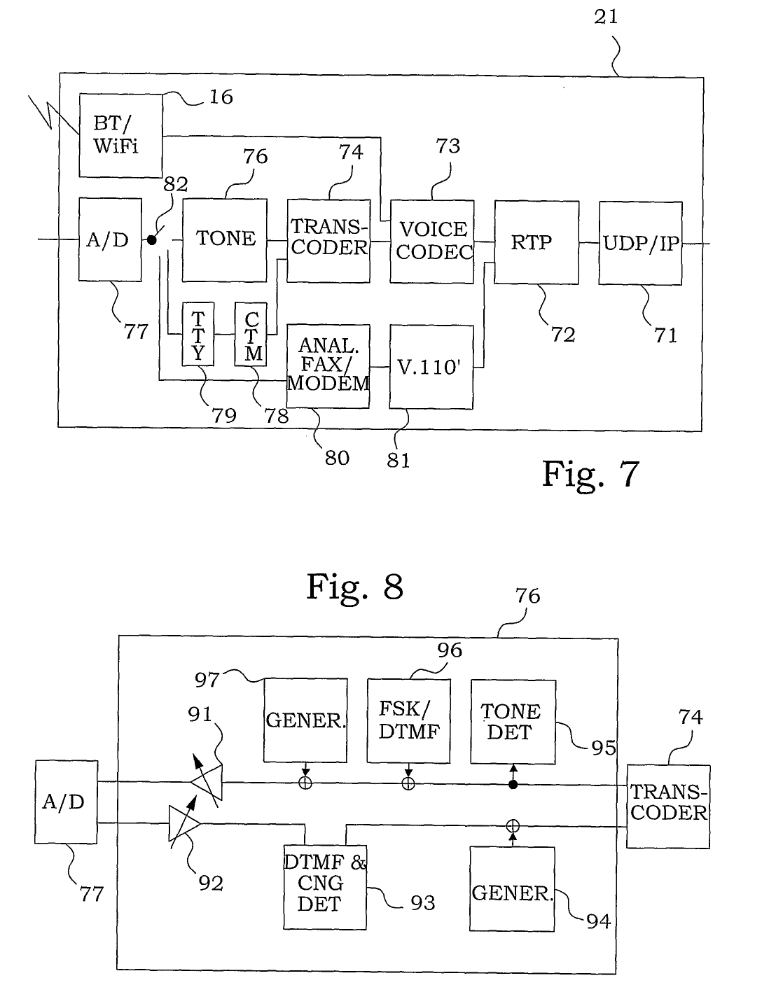

FIG. 7 illustrates a more detailed block scheme of an embodiment of an access point according to the present invention. For mobile station user data, a Bluetooth/WiFi interface 16 is connected to a voice codec 73. The codec is in turn connected to an RTP packing unit 72 and further to an UDP/IP packing unit 71 for providing suitable packets onto e.g. the Ethernet. This is made in accordance to the relevant IETF standards. Such functionalities are available according to e.g. the UMA standard.

POTS user data, however, requires additional functionalities. Signals from POTS equipment is digitalized in an A/D-converter 77. The type of signals is detected and alternative handling paths are provided. For voice type data, a tone handling unit 76, which is described more in detail below is connected to the A/D converter 77 by a switch 82. The data is then provided to a transcoder 74, which in turn is connected to the EFR converter 73, for merging with the mobile data plane. However, if text telephony is present, the data plane path is switched to a TTY modem 79 and a CTM modem before reaching the transcoder 74. The CTM modem is used to ensure TTY tones to pass through normal GSM voice codecs. If the POTS user data originally contains analogue fax or modem signals, the data plane path is switched to an analog fax/modem unit 80 and a V.110′ unit 81. V.110′ is used to transport data using GSM signalling. The data is then provided to the RTP packing unit 72.

Signals provided from the mobile communications network to the mobile phone or POTS equipment are processed in a corresponding manner but in the opposite direction.

FIG. 8 illustrates an embodiment of a tone handling unit 76, usable e.g. in the access point of FIG. 7. Upstream PCM signals are provided from the A/D converter 77 to a level adjustment 92 and further to a DTMF and fax/modem tone (CNG) detector, which decodes the received tones before sending them using the GSM signalling. A tone generator 94 is connected to the upstream line for generating Calling tone (CNG) and Answering tone (CED) for fax and data calls, before the upstream signal is provided to the transcoder 74. In the downstream direction, the transcoder signals are provided to a fax/modem tone detector 95, which determines if the downstream signal is a fax or modem signal. A FSK/DTMF generator 96 is connected to the downstream PCM line for providing FSK modulation, e.g. Bellcore GR-30-Core, V23 FSK modulation e.g. ETS 300 659-1 or DTMF pulses e.g. ETS 300 659-1 Annex C. A tone generator 97 is also provided to generate e.g. dial tone, ringing tone, busy tone or different guidance tones. Finally, the downstream signalling passes a level adjustment and volume control 91 before reaching the A/D converter 77.

One advantage with the present invention is that POTS telephony is made available without any substantial additional network operation costs for a subscriber. While costs for providing a POTS infrastructure is substantial, a mobile telephony operator can add the proposed POTS services to an existing network at only an incremental cost.

The use of a SIM card authentication reduces the cost of subscriber activation and administration significantly, and it will be possible to provide GSM/3G services such as prepaid also to fixed subscribers.

Any telephone in the global telephony network can be reached since the GSM/3G system is connected to the global telephony network. This would provide mobile operators with the tools to become complete “triple play” communication operators over fixed and radio communication.

The embodiments described above are to be understood as a few illustrative examples of the present invention. In most embodiments, a GSM/3GPP concept is assumed. However, the present invention is applicable also to other mobile communications systems, e.g. based on TDMA, CDMA-one, D-AMPS, PDC or PCS. It will furthermore be understood by those skilled in the art that various modifications, combinations and changes may be made to the embodiments without departing from the scope of the present invention. In particular, different part solutions in the different embodiments can be combined in other configurations, where technically possible. The scope of the present invention, however, is fully defined by the appended claims.

### REFERENCES

[1] UMA Architecture (Stage 2) R1.0.2 (2004-11-03) Technical specification, sections 4-7.

1. An access point, comprising:
an IP network physical interface, for connection to an access network;
said access network being arranged for providing access for mobile terminals to a mobile communications network over an IP connection;
a first converter connected to said IP network physical interface, arranged for converting IP signaling received on said IP network physical interface into mobile communications system signaling and for converting mobile communications system signaling into IP signaling for transmission on said IP network physical interface;
an analogue physical interface, arranged for communication with plain old telephony system (POTS) equipment;
a second converter connected to said analogue physical interface and said first converter;
said second converter being arranged for converting POTS signaling received on said analogue physical interface into mobile communications system signaling for provision to said first converter; and
said second converter being further arranged for converting mobile communications system signaling provided by said first converter into POTS signaling for transmission on said analogue physical interface.

2. The access point according to claim 1, further comprising means for providing an identity for said POTS equipment within said mobile communications system.

3. The access point according to claim 2, wherein said means for providing an identity comprises a subscriber identity module.

4. The access point according to claim 1, further comprising: radio interface, arranged for communication with mobile stations, said radio interface being connected to said first converter for providing and receiving mobile communications system signaling.

5. The access point according to claim 4, wherein said mobile communications system signaling is performed according to GSM/3GPP standards and said first converter is operating according to unlicensed mobile access (UMA) standards.

6. The access point according to claim 1, further comprising means for implementing POTS services not directly available from said mobile communications system.

7. The access point according to claim 6, wherein said means for implementing POTS services comprises generators for and detectors of POTS specific tones and pulses.

8. The access point according to claim 1, wherein said POTS services are selected from the list of: POTS voice support; POTS supplementary service; FAX support; modem support; text telephony support; and high speed circuit switch data support.

9. A method for providing mobile terminal access to a mobile communications network over an IP connection, the method comprising:
connecting to an access point, the access point comprising an IP network physical interface, for connection to an access network, said access network being arranged for providing access for mobile terminals to a mobile communications network over an IP connection;
utilizing a first converter that is connected to said IP network physical interface and arranged for converting IP signaling received on said IP network physical interface into mobile communications system signaling and for converting mobile communications system signaling into IP signaling for transmission on said IP network physical interface:
communicating with a plain old telephony system (POTS) via an analogue physical interface;
utilizing a second converter connected to said analogue physical interface and said first converter;
arranging said second converter for converting POTS signaling received on said analogue physical interface into mobile communications system signaling for provision to said first converter and
converting mobile communications system signaling provided by said first converter into POTS signaling utilizing said second converter for transmission on said analogue physical interface.

10. The method according to claim 9, further comprising providing an identity for said POTS equipment within said mobile communications system.

11. The method according to claim 10, wherein providing an identity further comprises utilizing a subscriber identity module.

12. The method according to claim 9 further comprising: radio interface arranged for communicating with mobile stations, utilizing a radio interface said radio interface being connected to said first converter for providing and receiving mobile communications system signaling.

13. The method according to claim 12, wherein said mobile communications system signaling is performed according to GSM/3GPP standards and said first converter is operating according to unlicensed mobile access (UMA) standards.

14. The method according to claim 9 further comprising implementing POTS services not directly available from said mobile communications system.

15. The method according to claim 14, wherein implementing POTS services comprises implementing generators for and detectors of POTS specific tones and pulses.

16. The method according to claim 9, further comprising selecting said POTS services from the list of: POTS voice support; POTS supplementary service; FAX support; modem support; text telephony support; and high speed circuit switch data support.
